(19) United States
(12) Patent Application Publication
(10) Pub. No.: US 2002/0007575 A1
(43) Pub. Date: Jan. 24, 2002

(54) Prismatic advertising billboard and actuating device therefor

(75) Inventor: Flavio Barcha, Sao Paulo (BR)

Correspondence Address: SUGHRUE, MION, ZINN, MACPEAK & SEAS, PLLC, 2100 Pennsylvania Avenue, NW, Washington, DC, 20037-3213, US

(73) Assignee: COMERCIAL & CONSTRUTORA BARCHA LTDA.

(21) Appl. No.: 09/864,180

(22) Filed: May 25, 2001

(30) Foreign Application Priority Data
May 25, 2000 (BR) MU8000955-7

(51) Int. Cl. G09F 11/02

(52) U.S. Cl. 40/505; 40/624

(57) ABSTRACT

A prismatic advertising billboard having a body 1 elaborated as from a cardboard sheet 2 cut and bent in such a fashion as to show the shape of a box 3, in the interior of which are disposed profiles 4 and 5, also produced in cut and bent cardboard sheet, being that between the profiles 4 and 5 are mounted prismatic pieces 6 actuated in a synchronized manner by an electric motor 7; the electric motor 7 is connected to a long hexagonal axle 8 that crosses and is supported on the bearings 9 fixed to the profile 5, being that each one of the bearings 9 receives a pulley 10 through which the hexagonal axle passes 8; each one of the pulleys 10 incorporates a pin 11, elaborated so as to interfere in a connector 12, that is coupled by encasing in a triangular profile 13 elaborated in a cut and bent cardboard sheet 14. The invention further provides an improved actuating mechanism, including an electric motor 112 to be mounted inside a non-inflammable casing 115, and a panel counting with an automatic disengagement device 132, formed by the head 134 attached to the extremity of the drive rod 111, and by a rotating part 135, which in turn is attached to the shaft 133 of the electric motor 112.

### BACKGROUND OF THE INVENTION

This present invention is directed to a prismatic advertising billboard/panel of the type composed of a frame filled in internally with an array of elongated prisms, whose faces comprise sectors forming an image, and for conveying varied types of publicity messages. The present invention also is directed to improvements introduced into the actuating means of such a publicity panel.

There are widely known publicity panels whose function and exhibition of images is based on the rotation of a series of prismatic parts, provided with external connectors, lodged in bearings which are interconnected between themselves by means of a single shaft which, jointly with a reducing gear drive is responsible for rotating and immobilizing the prismatic parts in full synchronism.

Each one of the faces of the prismatic parts presents an image sector which, when associated with the other sectors, is capable of composing an entire image. With the sequential rotation of the triangular cross section prismatic parts it is possible to contain and exhibit in sequence up to three images on the same panel.

In spite of its relative constructive simplicity, one aspect that limits the use of the above mentioned advertising billboard is the cost of its manufacturing, which makes its use prohibitive and restricted.

### SUMMARY OF THE INVENTION

Thus, one of the objectives of this invention is to provide a prismatic advertising billboard that can be constructed, mounted and utilized in a simple and inexpensive way, yet maintain sufficient rigidity and durability.

Another objective of this invention is to provide a special constructivity that when used in an advertising billboard of the above described type, besides lowering its costs of manufacturing, allows a greater facility and versatility of use, thus amplifying the field of application of this particular means of conveyance.

The present invention provides means enabling a user to assemble and use this publicity panel model in a simple and low cost manner, as compared with conventional panels, since their whole basic structure as well as its prismatic parts are manufactured from specific lightweight materials, such as cardboard or equivalent material. This permits more ease and versatility of use, thus increasing the application field of this particular means of vehiculation.

It is another objective of the present invention to provide improvements of the actuating means of a publicity panel, where all functions of the electric parts, as well as the electric motor are enclosed inside a non inflammable casing, such as a metal box, permitting total isolation of these elements in relation to the cardboard structure of the panel.

It is a further objective of this invention to provide a driving system of the prismatic parts with an innovative automatic disengaging device, acting in case of overload to their rotation, i.e., avoiding an excessive effort on the motor and other elements in case of, by chance, any of the prismatic parts suffering a failure or being inhibited from rotating freely for any reason.

The Applicant has also developed means providing more safety to the functioning of the panel, as well for its physical integrity, since the elements involved in the construction of major parts of its structure are inflammable, and the whole prism rotating system starts from the principle which employs an electric motor as driving means, here any failure could generate serious consequences to the panel.

In order to realize such objectives, a preferred embodiment includes a box manufactured from non inflammable material, preferably metal, and composed of a receiving body and a lid with appropriate characteristics, incorporating in one single assembly a three pole outlet and a fuse, in addition to a neon key, as well as an electric reducing gear drive for driving the prismatic parts. The automatic disengaging device, pertaining to the drive system of the prismatic parts, is positioned between the shaft of the reducing gear drive and the hexagonal rod promoting the synchronized movement of the prismatic parts, which contain in segmented form the images vehiculated by the panel.

### BRIEF DESCRIPTION OF THE DRAWINGS

For the purposes of illustrating aspects of the invention, the following drawings are provided to show embodiments that are presently preferred; it being understood, however, that this invention is not limited to the precise arrangements and instrumentalities shown.

FIG. 1 illustrates a perspective view of a prismatic billboard;

FIG. 2 illustrates a partially cut frontal view of the herein mentioned billboard;

FIG. 3 illustrates a perspective and isolated view of one of the employed bearings of the subject billboard;

FIG. 4 illustrates a view of each one of the pulleys that integrate the mounting of this billboard;

FIG. 5 illustrates one of the connectors employed in the subject panel;

FIG. 6 illustrates one of the prismatic pieces that integrate the herein described billboard;

FIG. 7 schematically illustrates a mounting of a prismatic piece in a set formed by a bearing and its respective pulley;

FIG. 8 is an exploded perspective of the panel in question, illustrating the improvements introduced into the same;

FIG. 9 is an enlarged detail in exploded perspective, where it is possible to better visualize the referred-to improvements; and

FIG. 10 illustrates a schematic front view of the publicity panel in question, with the improvements mounted at their respective locations.

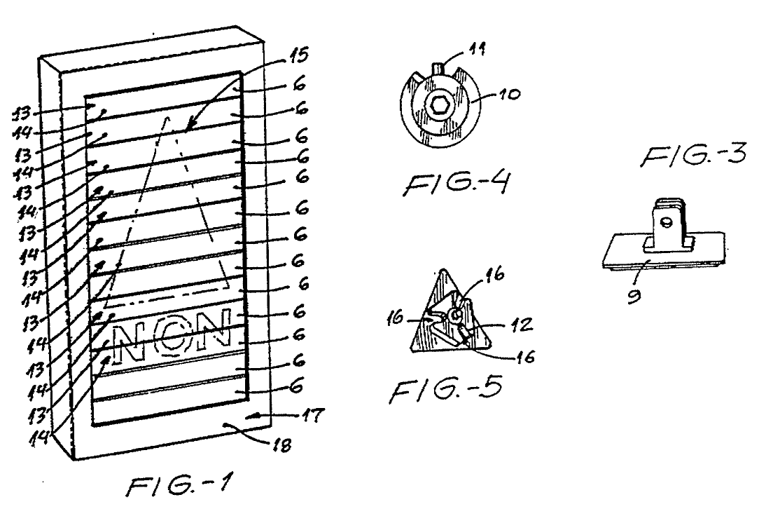

### DETAILED DESCRIPTION OF THE INVENTION

Embodiment 1

In conformity with the illustrations of the above listed figures, the advertising billboard object of this invention is characterized by the fact of being defined by a body 1 elaborated as from a sheet of cardboard 2 cut and bent so as to show the form of a box 3, in the interior of which are disposed lateral profiles 4 and 5, also produced in a sheet of cardboard cut and bent, being that between the profiles 4 and 5 are mounted prismatic pieces 6 actuated in a synchronized manner by an electric motor 7.

The electric motor 7 is connected to a long hexagonal axle 8 that crosses and is supported on the bearings 9 fixed to the profile 5, being that each one of the bearings 9 receive a pulley 10, through which passes the hexagonal axle 8.

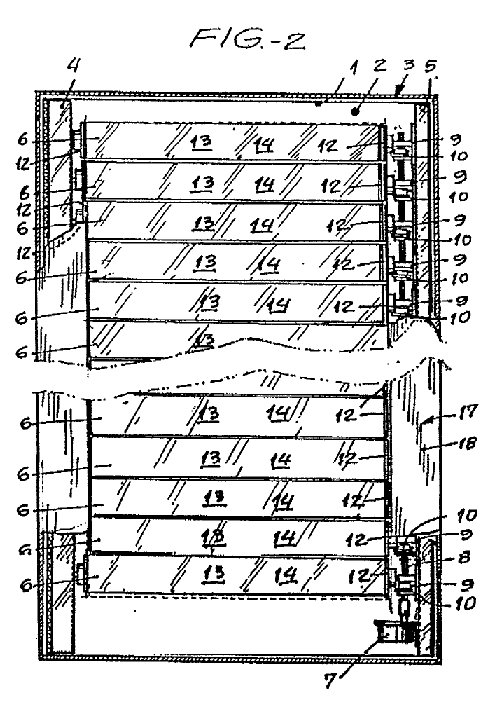

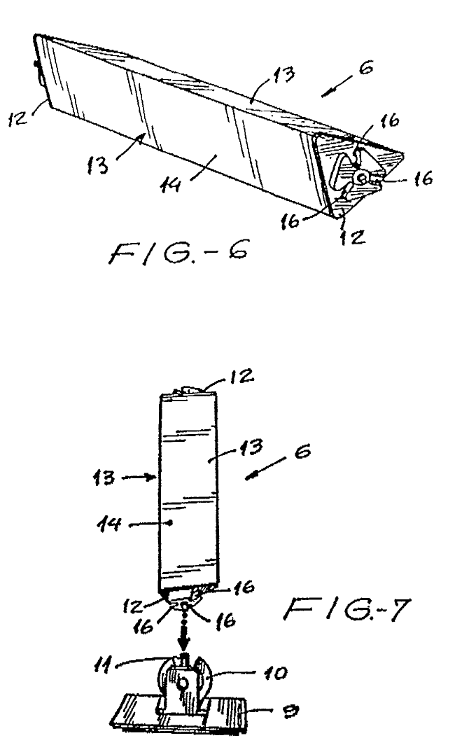

Each one of the pulleys 10 incorporates a pin 11, elaborated so as to interfere in one of the two connectors 12 that integrate each prismatic piece 6, such as may be better understood through the observation of FIG. 7, being that each connector 12 is coupled by encasing in a triangular profile 13 elaborated in card sheet 14 folded and bent.

The triangular profile 13 in each one of its faces, receives a segment of a total image 15. Each profile 13 may incorporate up to three segments of total images, that are exposed according to the size of the synchronized spin of all the prismatic pieces 6.

The profiles 13 associated to the connectors 12 define a prismatic piece 6 that may be easily substituted, and this renders the present billboard substantially versatile from an operational viewpoint.

The rotation of the connectors 12 is obtained when the pin 11 of its respective pulley 10 interferes with one of its three grooves 16 of the connector 12 that is pivoted close to the bearing 9. This occurs at every full rotation of the hexagonal axle 8.

In this manner, it is possible to synchronize the rotation of all prismatic pieces 6 so as to exhibit the faces of each one of the profiles that correspond to each one of the three total images.

The subject billboard comprises, further, a frame 17, also produced in cardboard sheet 18 cut and bent, being said frame mounted close to the body 1 of the billboard, so as to hide the operational devices of the same.

Such as may be concluded, the subject advertising billboard features a simple constructivity, that is viabilized with the employment of low cost materials produced also in a quick and inexpensive way.

Embodiment 2

In accordance with a second embodiment as shown in FIGS. 8-10, the present invention provides a panel defined by a body 101, constituted from a sheet 102, manufactured preferably from cardboard or other similar material shown to be adequate.

The sheet 102 forming the basic structure of the body 101 is cut and folded in order to configure a box 103, which receives at its inside lateral tubular profiles 104 and 105, also manufactured from the same material as the body 101, i.e. cardboard or other similar material shown to be adequate, as well as the upper frame 106 and the lower frame 107.

Inside box 103, more precisely between the lateral tubular profiles 104 and 105, are placed prismatic parts 108, provided at their extremities with the correspondent connectors 109.

The connectors 109 of the same side of the set of prismatic parts 108 are lodged in corresponding bearings 110, there being one bearing 110 for each of the prismatic parts 108, where it should be emphasized that for illustration purposes only one bearing unit 110 was represented on FIG. 8.

The set of bearings 110 is trespassed by a driving rod 111, connected to the electric motor 112, the referred-to driving rod 111 being responsible for the synchronized actuation of the prismatic parts 108 of the panel in question.

As to the set of prismatic parts 108 and more specifically with regard to each prismatic part taken individually, the extremity opposed to the side lodged in the corresponding bearing 110 incorporates also a connector 109, which in turn is mounted rotatively in a corresponding orifice 113, which is a part of the set of orifices incorporated equidistantly at the internal face of the tubular profile 105.

Each one of the connectors 109 mounted on both extremities of each one of the prismatic parts 108 incorporates a pin shaped projection 114, which permits, at one side, the assembly close to the bearings 110, as well as on the other hand, its assembly in any one of the orifices 113 incorporated into the lateral tubular profile 105.

According to this embodiment, electric motor 112 is located inside a non inflammable casing configured as a metal box 115, composed of a receiving body 116 and provided with carved orifices 117 and 118 and a lid 120 provided with an upper base 120 and lateral rims 121 and 122, one of them, i.e. rim 121, being slightly projected, configuring a space (x); said rims 121 and 122 being provided with carved orifices 123 and 124 coinciding, respectively, with the orifices 117 and 118 of the receiving body 116, permitting the attachment between both parts of the box 115.

The upper base of the lid 119 comprehends openings 125 and 126, capable to receive and attach an assembly 127, composed of a three pole outlet 128 and a fuse 129; and an on/off key 130, whose wiring 131 is connected to the motor 112.

Box 115, by means of the projecting rim 121, is snapped in with support at the upper edge of the profile 104, which for its turn is lodged inside the space X of the box, there being attached by convenient means through the orifices 117 and 123 of the said box.

The type of assembly described above results in the fact that the box 115, after being duly attached to the panel, acquires a condition of total immobility, since it is locked in a first direction close to the profile 104, by the latter being snapped into the space X, in another direction it is also locked by the width of the rim 121, which is introduced into the profile 104 and finally is locked in a third direction by the snapping in of the assembly formed by the profile 104 and the box 115 inside the structure of the panel.

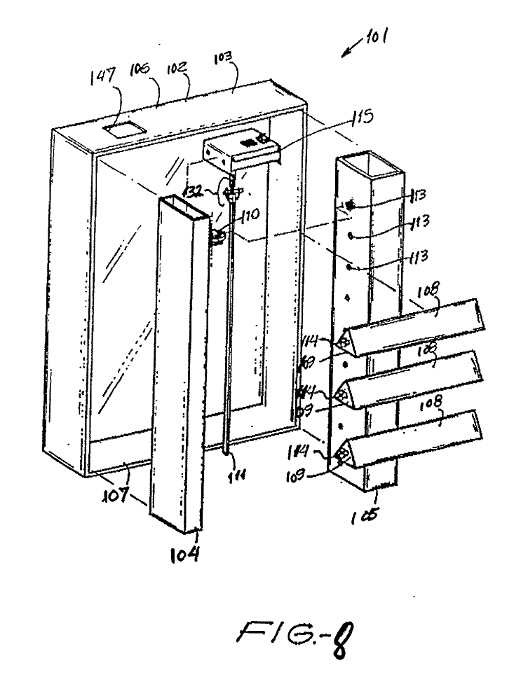

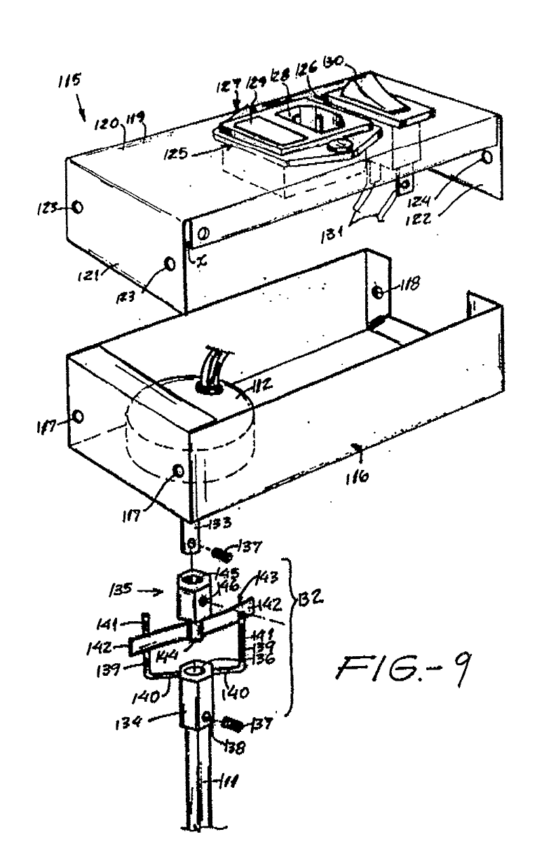

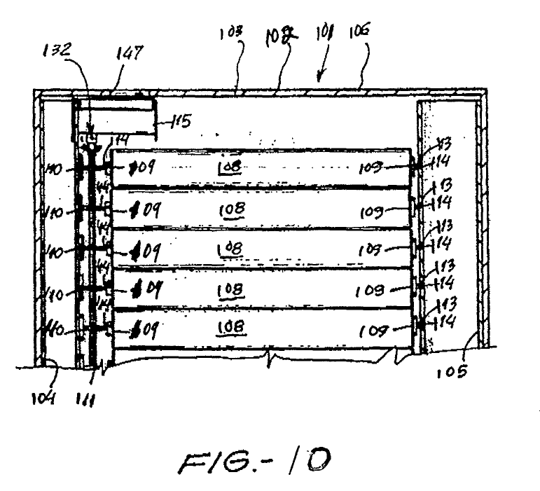

An automatic disengaging device is provided between the shaft 133 of the electric motor 112 and the drive rod 111, as can be better understood by observing FIG. 9, the referred-to automatic disengagement device 132 being formed essentially by the head 134, attached to the extremity of the drive rod 111, and by the rotating part 135, for its turn attached to the already mentioned shaft 133 of the electric motor 112.

The head 134 presents a tubular structure, counting with an axial orifice 136, which is duly configured to receive in an adjusted form the extremity of the drive rod 111, the attachment between the referred-to head 134 and the drive rod 111 being produced by a retaining element 137, which may assume the form of a bolt or other element which shows itself adequate, assembled into a radial orifice 138 incorporated into the body of the mentioned head 134.

The head 134 incorporates further a pair of symmetric arms 139, mutually opposed, each of which formed by a radial branch 140 which develops orthogonally into a branch 141, parallel to the geometric axis of the drive 111.

As can be better understood by observing FIG. 9, the orthogonal branches 141 of the symmetric arms 139 are projected beyond the height level of the extremity of the body of the head 134, so that such orthogonal branches 141 are in condition to establish the mechanical coupling with the opposite extremities 142 of a flexible blade 143, trespassing a projection 144 which integrates the main structure of the rotating part 135.

The rotating part 135, such as the head 134, presents a tubular structure, counting with an axial orifice 145, which in the specific case of the referred-to rotating part 135 is duly configured to receive in an adjusted form the extremity of the shaft 133 of the electric motor 112, the attachment between the referred-to rotating part 135 and the mentioned shaft 133 of the electric motor 112 being produced by a retaining element 137, which may assume the form of a bolt or other element which shows itself adequate, assembled into a radial orifice 146 incorporated into the body of the mentioned rotating part 135.

The automatic disengagement device 132, illustrated in detail in FIG. 9, presents a simple and efficient functional conception, based on the actuation of the flexible blade 143 of the rotating part 135 on the head 134 assembled on the drive rod 111.

Thus, under normal operating conditions, the electric motor 112 causes through its shaft 133 the rotation of the rotating part 135, which due to its flexible blade 143 presenting a width larger than the distance of the orthogonal branches 141 from the symmetric arms 139 of the head 134, determines the engagement and consequent rotation of this latter component.

Since the head 134 is rigidly attached to the drive rod 111, the rotation of the mentioned head determines also obligatory rotation of the drive rod 111, thus producing the synchronized drive of the prismatic parts 108.

The flexibility of the blade 143 is calibrated in a manner that its extremities 142 will support the normal load represented by the rotating effort of the drive rod 111 in order to produce the synchronized movement of the prismatic parts 108, without this force being sufficient to determine the disengagement of the rotating part 135 from the head 134.

This way, under normal operating conditions of the panel, the assembly formed by the drive rod 111 and the head 134 is forced to rotate (in this process driving the prismatic parts 108), in function of the direct actuation of the rotating part 135 coupled to the shaft 133 of the motor 112.

In the eventuality of an overload occurring to the electric motor 112, which may be represented, for example, by accidental locking (temporary or permanent) of one or more prismatic parts 108, the breaking of some component or even for any reason impairing the free rotation of the mentioned prismatic parts 108, a condition of increasing the effort imposed on the flexible blade 143 will be verified.

The elevation of the effort transmitted to the flexible blade 143 produces proportionally an increased flexion of its extremities 142, culminating at a point at which that effort causes a flexion index sufficient to cause the mentioned extremities 142 to lose the contact with the orthogonal branches 141 of the symmetric arms 139 of the head 134.

When the contact between the extremities 142 of the flexible blade 143 with relation to the mentioned orthogonal branches 141 of the symmetric arms 139 of the head 134 is lost, a “false rotation” effect of the rotating part 135 in relation to the head 134 occurs, an effect accompanied by a cracking sound, resulting exactly from the disengagement of the flexible blade 143 and from the rotation stop of the prismatic parts 108. At this point the electric motor 112 rotates freely until the extremities 142 of the blade 143 touch again the orthogonal branches 141 of the symmetric arms 139, causing again a new disengagement and resulting again in a cracking sound.

Thus, the electric motor 112 is not submitted to an excessive effort which could eventually cause, for example, its superheating or even more serious damages.

On the other hand, the intermittent generation of the cracking sound at every new engagement and consequent disengagement of the rotating part 135 in relation to the head 134, serves as an alert signal in order to note the abnormality of the panel more easily.

In respect to the mounting of the box 115 on the body 101 of the panel, a window 147 is provided on the upper frame 106 of the box 103, in order to expose the fuse 129, the outlet 128 and the on/off key 130, the referred-to window 147 being dimensioned for allowing the free access of the user to the mentioned components.

Once described the improvements, it will become clear that the publicity panel in question continues to present a simple construction, not evading the initial idea of composing it from low cost materials, in addition of presenting a fast assembly. Said panel also incorporates a safety system against possible accidents with the electric part, as well as being equipped with an automatic disengagement system 132, which avoids overload of force on the electric motor 112, caused by any failure of the prismatic elements or other components associated to the same.

In spite of the invention having been detailed, it is important to understand that the same is not limited in its applications to the details and steps described here. The invention is capable of other modalities and to be practiced or performed in a variety of modes. It shall be understood that the terminology applied here is for the purpose of description and not of limitation.

What is claimed is:

1. A prismatic billboard comprising:
a body made from a cardboard sheet cut and bent in such a way as to present the form of a box;
at least two lateral profiles disposed in the interior of said body, said lateral profiles being produced from cut and bent cardboard sheets;
prismatic profiles produced from cut and bent cardboard sheets, said prismatic profiles mounted between said lateral profiles;
an electric motor for actuating said prismatic profiles in a synchronized manner, the electric motor being connected to a hexagonal axle that crosses and is supported on bearings fixed to one of said lateral profiles, each one of the bearings receiving a pulley through which the hexagonal axle crosses, each of the pulleys incorporating a pin, said pin structured so as to interfere in a connector that is coupled by encasing in one of said prismatic profiles.

2. A prismatic billboard according to claim 1, wherein rotation of said connector is obtained when the pin of its respective pulley interferes with one of three grooves in said connector, said interference occurring at each full rotation of the hexagonal axle.

3. A prismatic billboard according to claim 1, further comprising a frame produced from a cut and bent cardboard sheet, said frame being mounted in proximity to the body so as to hide operational devices of said billboard.

4. A prismatic billboard according to claim 1, wherein said electric motor and said associated electronics are housed in a box that is more fire retardant than said cardboard.

5. A prismatic billboard according to claim 1, further comprising a drive coupling between said electric motor and said axle that disengages when a force from said motor exceeds a predetermined amount.

6. A prismatic billboard comprising:
a body constituted from cardboard, said cardboard forming the basic structure of the body being cut and folded in order to configure a box incorporating an upper frame and a lower frame;
a drive rod coupled to said electric motor so as to be rotated by a turning action of said electric motor;
at least two lateral tubular profiles received in the interior of said body on opposite sides from each other, said lateral tubular profiles also manufactured from cardboard and having a plurality of orifices;
an electric motor located inside a non inflammable casing configured by a metallic box, composed of a receiving body and provided with receiving-body-orifices and a lid provided with an upper base and lateral rims, at least one rim being slightly projected and configuring a space (x), said rims being provided with rim-orifices coinciding respectively with said receiving-body-orifices and permitting the attachment between said lid and receiving body, the upper base of the lid comprising openings capable to receive and attach an assembly comprising a three pole outlet and a fuse, and an on/off key having wiring connected to the motor, said metallic box being installed in said body such that said projected rim is supported on an upper edge of one of said lateral tubular profiles such that, a portion of said one of said lateral tubular profile is inserted into space (x) of the box and fastened via at least one of the orifices of said projected rim;
prismatic parts inside said box extending between said lateral tubular profiles, said prismatic parts provided with corresponding connectors on each side of said prismatic parts that points towards one of said lateral tubular profiles, the connectors on a first side of said prismatic parts being lodged in corresponding bearings, one bearing for each one of the prismatic parts, said bearings being trespassed by said drive rod, said drive rod being responsible for synchronized actuating of the prismatic parts, each one of said connectors incorporating a pin shaped projection which permits mating with a corresponding orifice of one of said lateral tubular profiles.

7. A prismatic billboard according to claim 6, further comprising:
an automatic disengagement device provided between the shaft of the electric motor and the drive rod, said automatic disengagement device being primarily formed with a tubular head attached to an end of the drive rod with an axial orifice configured to receive in an adjusted form the end of the drive rod, said automatic disengagement device also being formed by a rotating part, which by turning is coupled with said shaft of the electric motor, the attachment between said head and said drive rod being produced by a retention element mounted on a radial orifice incorporated into the body of said head,
wherein said head incorporates further a pair of symmetric arms disposed in mutual opposition, each one of said symmetric arms formed by a radial branch which develops orthogonally into a branch parallel to the geometric axis of the drive rod.

8. A prismatic billboard according to claim 7, wherein the orthogonal branches of the symmetric arms are projected beyond the height level of the extremity of the head so that such orthogonal branches are in condition to establish mechanical coupling with the opposed extremities of a flexible blade trespassing a projection which integrates the main structure of the rotating part.

9. A prismatic billboard according to claim 8, wherein the rotating part is a tubular structure with an axial orifice configured to receive in an adjusted form an end of the shaft of the electric motor, the attachment between the rotating part and the shaft of the electric motor being produced by a retention element mounted on a radial orifice incorporated into the body of the rotating part.

10. A prismatic billboard according to claim 8, wherein the flexibility of the blade is calibrated in a manner so that its extremities support a normal load represented by force of rotating the drive rod for producing the synchronized movement of the prismatic parts without being sufficient to cause disengagement between the rotating part and the head.

11. A prismatic billboard according to claim 6, further comprising a window on the upper frame of the box in order to expose the fuse, the outlet, and the on/off key, said window being dimensioned for permitting access of the user to the mentioned components.
